(19) United States
(12) Patent Application Publication
(10) Pub. No.: US 2025/0385286 A1
(43) Pub. Date: Dec. 18, 2025

(54) POST HUMIDIFIER FUEL CELL STACK HUMIDIFICATION SYSTEM

(71) Applicant: Caterpillar Inc., Peoria, IL (US)

(72) Inventor: Andrew D. Wuethrich, Peoria, IL (US)

(21) Appl. No.: 18/742,872

(22) Filed: Jun. 13, 2024

(51) Int. Cl. H01M 8/04828; H01M 8/04119; H01M 8/0432; H01M 8/0438; H01M 8/04492; H01M 8/04746

(52) U.S. Cl. CPC H01M 8/04835; H01M 8/04126; H01M 8/04156; H01M 8/04373; H01M 8/04425; H01M 8/04507; H01M 8/04776

(57) ABSTRACT

A method for controlling the humidity of a fuel cell stack air inlet, a fuel cell system in which the method may be exercised, and a fuel cell system controller adapted to execute the method in a fuel cell system. The method for controlling the humidity includes detecting the humidity of air entering a fuel cell stack air inlet downstream a humidifier, detecting the water level of a water reservoir, and using the detected values to control the humidity of air entering the fuel cell stack by controlling a supply of water from the water reservoir to a spray nozzle downstream the humidifier.

### TECHNICAL FIELD

This patent disclosure relates generally to fuel cells and, more particularly to arrangements for adjusting the humidity level of a fuel cell.

### BACKGROUND

Fuel cell systems are utilized in various application including, for example, electric vehicles. When the humidity level at the stack air inlet of a fuel cell is too low or too high, the power output of the fuel cell stack is reduced. Usually, the humidity is lower than it needs to be during transient loading events or in dry-ambient conditions, which may cause delays in power output during load ramps.

CN211654965U discloses a fuel cell system that humidifies air while reducing the temperature of the air by spraying water recovered from the fuel cell stack into the air supplied from a compressor to an intercooler. The intercooler passes the air with the water to the fuel cell stack.

### SUMMARY

The disclosure describes, in one aspect, a method for controlling the humidity of a fuel cell stack air inlet. The method includes detecting the humidity of air entering a fuel cell stack air inlet downstream a humidifier, detecting the water level of a water reservoir, and using the detected values to control the humidity of air entering the fuel cell stack by controlling a supply of water from the water reservoir to a spray nozzle downstream the humidifier.

The disclosure describes, in another aspect, a fuel cell system including a fuel cell stack including a stack air inlet, a humidifier including a humidifier outlet disposed upstream the fuel cell stack, and a spray nozzle disposed between the humidifier outlet and the stack air inlet. The fuel cell system further includes a reservoir fluidly coupled to the spray nozzle to provide water from the reservoir to the air downstream the humidifier and upstream the stack air inlet. A solenoid valve is disposed to control flow of water from the reservoir to the spray nozzle. A stack inlet humidity sensor is disposed to detect a humidity of air entering the stack air inlet. A controller is configured receive signals from the stack inlet humidity sensor and to control operation of the solenoid at least based upon the signals from the stack inlet humidity sensor.

The disclosure describes, in yet another aspect, a fuel cell system controller adapted to control operation of a fuel cell system including a fuel cell stack having a stack air inlet, a stack inlet humidity sensor disposed to detect a humidity of air entering the stack air inlet, a humidifier including a humidifier outlet, the humidifier outlet being disposed upstream the fuel cell stack and the stack inlet humidity sensor, a reservoir, a spray nozzle disposed to provide water from the reservoir to the air downstream the humidifier and upstream the stack air inlet, and a solenoid valve disposed to control flow of water from the reservoir to the spray nozzle. The fuel cell system controller is configured to receive from the stack inlet humidity sensor downstream the humidifier a signal indicative of a detected humidity at the stack air inlet. The fuel cell controller uses the detected value to control operation of the solenoid valve to provide a supply of water from the water reservoir to the spray nozzle downstream the humidifier and upstream the stack air inlet in order to control the humidity of air entering the fuel cell stack.

### BRIEF DESCRIPTION OF THE DRAWING(S)

FIG. 1 is a schematic view of a system for providing humidity to a fuel cell stack in accordance with this disclosure.

FIG. 2 is a schematic view of another embodiment of a system for providing humidity to a fuel cell stack in accordance with this disclosure.

FIG. 3 is a chart illustrating a method of providing humidity to a fuel cell stack in accordance with this disclosure.

### DETAILED DESCRIPTION

This disclosure relates to a system and method for controlling the humidity of air provided to a fuel cell stack 10 at a fuel cell stack air inlet 12, and a fuel cell system 8 incorporating the same. Compressed air is provided from an air compressor 14 to a humidifier 16, which is directed toward via supply passage 18 via a humidifier outlet 17 to the fuel cell stack air inlet 12. A fuel cell exhaust line 22 is fluidly coupled to the fuel cell stack 10. Exhaust from the fuel cell stack 10 is directed to a water separator 20 via the fuel cell exhaust line 22 fluidly. In this way, the fuel cell exhaust line 22 is fluidly connected to the water separator 20. Recovered water from the water separator 20 is directed to a reservoir 24 via a line 26, while the remaining fuel cell exhaust is directed through exhaust line 28.

In order to further control and provide humidification to the supply passage 18 and on to the fuel cell stack 10, a pump 30 pumps water from the reservoir 24 via water line 32 and on to a solenoid valve 34 via water line 36. The solenoid valve 34 may be opened and closed to control a further flow of water to a spray nozzle 38 via flow path 40. According to an aspect of this disclosure, the spray nozzle 38 directs water to the supply passage 18 between the humidifier 16 and the fuel cell stack 10. In this way, the recovered water from the fuel cell exhaust line 22 is inserted into the air stream prior to the air entering the fuel cell stack 10 provided to further control the humidity of the air in order provide optimal humidity level for efficient operation of the fuel cell stack 10.

The system may be provided with a number of sensors in order to control the operation of the humidification system. For example, a water level sensor 42 may be provided to sense the water level in the reservoir 24 in order to determine whether the pump 30 may safely operate to provide a flow of water to the solenoid valve 34. A fluid pressure sensor 44 may be provided to sense the pressure of within the water line 36 between the pump 30 and the solenoid valve 34.

In order to provide information regarding the level of humidity within the supply passage 18 for the fuel cell stack 10, a stack inlet humidity sensor 46 may be provided. Significantly, the stack inlet humidity sensor 46 is provided downstream both the humidifier 16 and the spray nozzle 38. In this way, for example, information from the stack inlet humidity sensor 46 regarding the humidity level in the supply passage 18, as well as information from the fluid pressure sensor 44 may be used to determine selective operation of the solenoid valve 34 in order to provide an appropriate spray from the spray nozzle 38 to provide a desired humidity level in the flow proceeding to the fuel cell stack 10. Information from the water level sensor 42 may be utilized to ensure that there is adequate water in the reservoir to provide the desired flow to the solenoid valve 34, and spray nozzle 38.

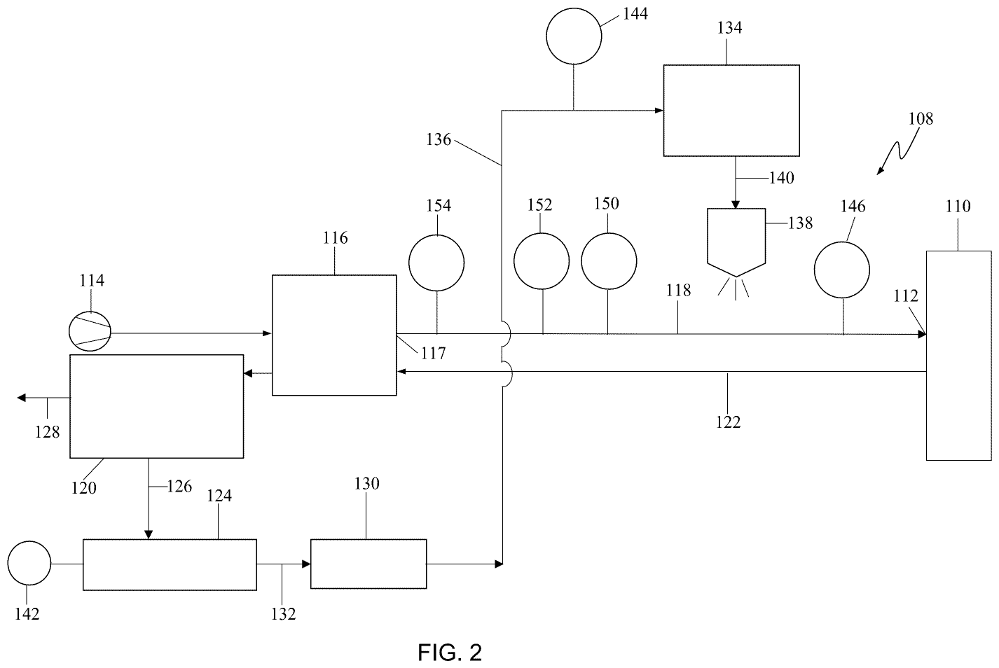

Another embodiment of the system and method for providing humidity to a fuel cell stack 110 and controlling the humidity at a fuel cell stack air inlet 112 is illustrated in FIG. 2. For the interests of clarity, similar elements are identified by the same numbers, prefaced by a “1”. Compressed air is provided from an air compressor 114 to a humidifier 116, which is directed toward via a humidifier outlet 117 to a supply passage 118 to the fuel cell stack air inlet 112. In this embodiment, exhaust from the fuel cell stack 110 is directed to a water separator 120 via fuel cell exhaust line 122 and the humidifier 116. Recovered water from the water separator 120 is directed to a reservoir 124 via a line 126, while the remaining fuel cell exhaust is directed through exhaust line 128.

In order to further control and provide humidification to the supply passage 118 and on to the fuel cell stack 110, a pump 130 pumps water from the reservoir 124 via water line 132 to a solenoid valve 134 via water line 136. The solenoid valve 134 may be opened and closed to control a further flow of water to a spray nozzle 138 via flow path 140. According to an aspect of this disclosure, the spray nozzle 138 directs water to the supply passage 118 between the humidifier 116 and the fuel cell stack 110. In this way, the recovered water from the fuel cell exhaust line 122 is inserted into the air stream prior to the air entering the fuel cell stack 110 to further control the humidity of the air in order provide optimal humidity level for efficient operation of the fuel cell stack 110.

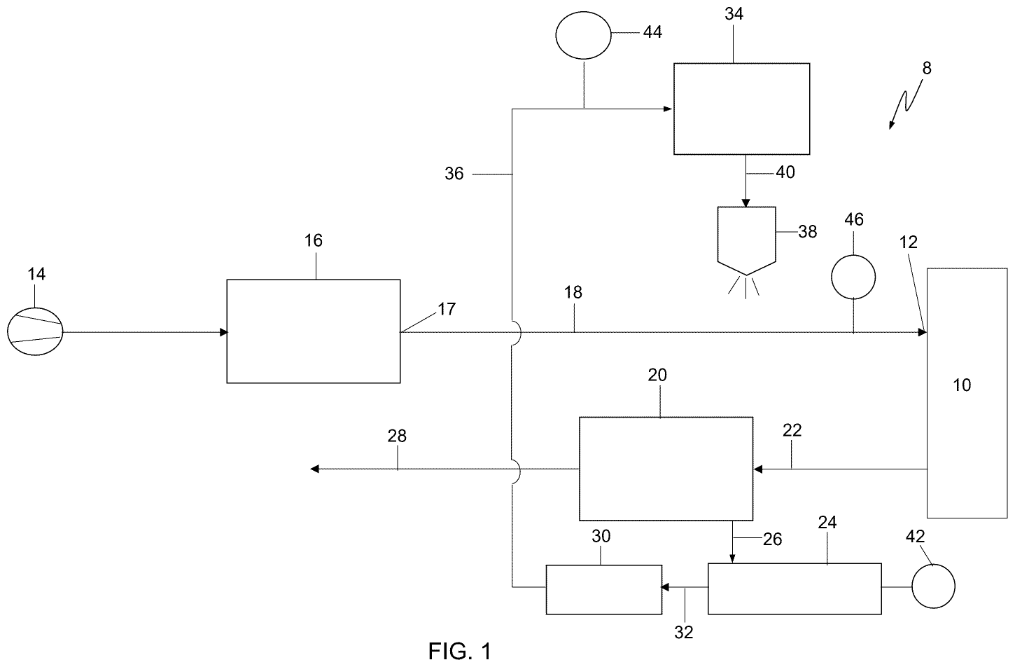

The embodiment of FIG. 2 likewise may be provided with a number of sensors in order to control the operation of the humidification system. As with the embodiment of FIG. 1, one or more of the following sensors may be provided: a water level sensor 142 to sense the water level in the reservoir 124, and a fluid pressure sensor 144 to sense the pressure of within the water line 136 between the pump 130 and the solenoid valve 134. A stack inlet humidity sensor 146 disposed downstream both the humidifier 116 and the spray nozzle 138 to sense the humidity within the supply passage 118 supplying the fuel cell stack 110. In this way, for example, information from the stack inlet humidity sensor 146 regarding the humidity level in the supply passage 118, as well as information from the fluid pressure sensor 144 may be used to determine selective operation of the solenoid valve 134 in order to provide an appropriate spray from the spray nozzle 138 in order to achieve a desired humidity level in the flow proceeding to the fuel cell stack 110.

The embodiment of FIG. 2, however, may include additional sensors disposed, for example, between the humidifier 116 and the spray nozzle 138. More specifically, a humidifier outlet pressure sensor 150, a humidifier outlet temperature sensor 152, and a humidifier outlet humidity sensor 154 may be provided in order to sense the humidifier outlet pressure, humidifier outlet temperature, and the humidifier outlet humidity, respectively. In this way, information from the humidifier outlet pressure sensor 150, the humidifier outlet temperature sensor 152, and the humidifier outlet humidity sensor 154 upstream the spray nozzle 138, may be utilized in addition to information from the stack inlet humidity sensor 146 regarding the humidity level in the supply passage 118 downstream the spray nozzle 138. That is, such information may be provided in addition to information from the fluid pressure sensor 144 may be used to determine selective operation of at least the solenoid valve 134 in order to provide an appropriate spray from the spray nozzle 138 to provide a desired humidity level in the flow proceeding to the fuel cell stack 110. The information may additionally be utilized from the fluid pressure sensor 144 in the determination of the appropriate time frame and position of the solenoid valve 134. Information from the water level sensor 142 may be utilized to ensure that there is adequate water in the reservoir to provide the desired flow to the solenoid valve 134, and spray nozzle 138.

### INDUSTRIAL APPLICABILITY

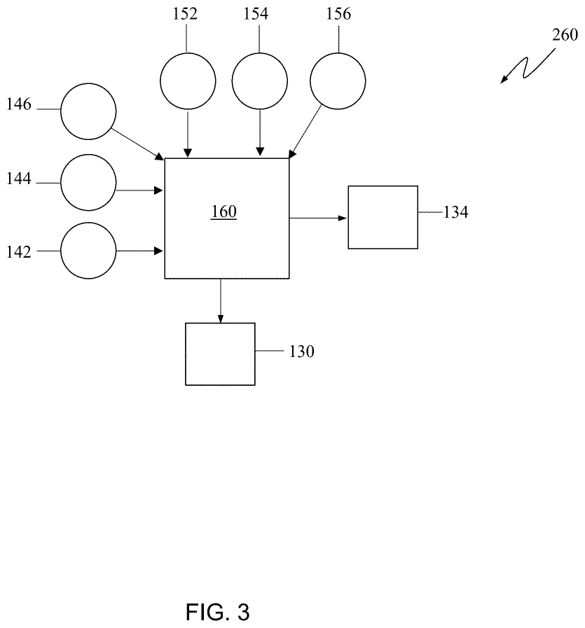

The present disclosure is applicable to systems for providing humidity to a fuel cell stack. There is illustrated in FIG. 3, an exemplary arrangement for a control system 260 to control certain aspects of the system for providing humidity to a fuel cell stack 110.

The control system 260 may be a stand-alone system, may include other systems including those within, or associated with the system for providing humidity to a fuel cell stack. Control system 260 may include components located proximally to the fuel cell stack 10, 110 as illustrated, for example, in FIGS. 1 and 2, and may also include components located remotely. As a result, the functionality of control system 260 may be distributed so that certain functions are performed at a worksite and other functions are performed remotely, such as at a remote operations center. The control system 260 may include a communications system including both a wireless communications system at a command center (not shown) and wired communications systems (not shown) for transmitting signals between components.

The control system 260 may include an electronic control module or controller 160 that may receive various input signals from wireless communications system (not shown), wired communications systems (not shown), control systems and sensors associated with the system for providing humidity to a fuel cell stack 10, 110 such as the illustrated arrangements, or from any other source. The control system 260 and controller 160 may control and provide input to the operation of various aspects of the arrangement including the provision of humidity to the fuel cell stack 10, 110.

The controller 160 may be an electronic controller that operates in a logical fashion to perform operations, execute control algorithms, store and retrieve data and other desired operations. The controller 160 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 160 such as power supply circuitry, signal conditioning circuitry, driver circuitry, and other types of circuitry.

The controller 160 may be a single controller or may include more than one controller disposed to control various functions and/or features of the control system 260. The term “controller” is meant to be used in its broadest sense to include one or more controllers and/or microprocessors that may be associated with the arrangements illustrated in FIGS. 1 and 2, and/or other operations, and that may cooperate in controlling various functions and operations relative to the fuel cell stack 10, 110 at a worksite and of the machines. The functionality of the controller 160 may be implemented in hardware and/or software without regard to the functionality. The controller 160 may rely on one or more data maps relating to the operating conditions and environment as well as characteristics and capabilities of the machines that may be stored in the memory of controller 160.

While the arrangement illustrated in FIG. 3 is particularly applicable to the embodiment illustrated in FIG. 2, those of skill in the art will appreciate that the illustrated arrangement is likewise applicable to the arrangement of FIG. 1, without the inclusion of the humidifier outlet pressure sensor 150, the humidifier outlet temperature sensor 152, and the humidifier outlet humidity sensor 154.

As illustrated in FIG. 3, the sensors 142, 144, 146, 152, 154, 156, if provided, provide signals to a controller 160. That is, if provided, the water level sensor 142 may provide a signal to the controller 160 representing the water level in the reservoir 124, in order to ensure adequate water exists for pumping to the solenoid valve 134. If provided, the fluid pressure sensor 144 may provide a signal to the controller 160 representing the pressure of within the water line 136 between the pump 130 and the solenoid valve 134. The stack inlet humidity sensor 146 provides a signal to the controller 160 representing the humidity within supply passage 118 downstream both the humidifier 116 and the spray nozzle 138. Likewise, if provide, the humidifier outlet pressure sensor 150, the humidifier outlet temperature sensor 152, and the humidifier outlet humidity sensor 154 may provide respective signals representing the pressure, temperature, and humidity of the air within the supply passage 118 between the humidifier 116 and the spray nozzle 138. The controller 160 may then determine the appropriate time span, and degree to which the solenoid valve 134 should or should not be opened, as well as the operation of the pump 130.

Those of skill in the art will appreciate that the inclusion of the humidifier outlet pressure sensor 150, the humidifier outlet temperature sensor 152, and the humidifier outlet humidity sensor 154 along with the stack inlet humidity sensor 146 may facilitate the provision of a more accurate determination of a desired position and time frame for operation of the solenoid valve 134 and provision of water to the spray nozzle 138 than a determination based solely on the signals from the stack inlet humidity sensor 146 and fluid pressure sensor 144.

In this way, information from the humidifier outlet pressure sensor 150, the humidifier outlet temperature sensor 152, and the humidifier outlet humidity sensor 154 upstream the spray nozzle 138, may be utilized in addition to information from the stack inlet humidity sensor 146 regarding the humidity level in the supply passage 118 downstream the spray nozzle 138. That is, such information may be provided in addition to information from the fluid pressure sensor 144 may be used to determine selective operation of the solenoid valve 134 in order to provide an appropriate spray from the spray nozzle 138 to provide a desired humidity level in the flow proceeding to the fuel cell stack 110. Information from the water level sensor 142 may be utilized to ensure that there is adequate water in the reservoir 124 to provide the desired flow to the solenoid valve 134, and spray nozzle 138.

Some embodiments of the disclosed arrangement may be facilitate a more accurate provision of humidified air to a fuel cell stack. In some embodiments, this may provide more efficient operation of the fuel cell stack and provision of power. In some embodiments, this may result the elimination or reduction of delays in the provision of power from the fuel cell stack.

Some embodiments may be particularly efficient in the utilization of water recovered from the exhaust of the fuel cell stack, rather that utilization of an external source of water.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We/I claim:

1. A method for controlling a humidity of air entering a fuel cell stack air inlet comprising:
detecting a value of the humidity of air entering the fuel cell stack air inlet downstream a humidifier,
detecting a water level of a water reservoir, and
using detected values of the humidity of air entering the fuel cell stack air inlet to control a supply of water from the water reservoir to a spray nozzle disposed downstream the humidifier to control the humidity of air entering the fuel cell stack.

2. The method of claim 1 further including detecting a humidifier outlet humidity upstream the spray nozzle, and using detected values of the humidifier outlet humidity and the humidity of air entering the fuel cell stack air inlet to control the supply of water from the water reservoir to the spray nozzle downstream the humidifier to control the humidity of air entering the fuel cell stack.

3. The method of claim 2 further including detecting a humidifier outlet temperature, and detecting a humidifier outlet pressure, and using detected values of the humidifier outlet temperature and pressure to control the supply of water from the water reservoir to the spray nozzle downstream the humidifier to control the humidity of air entering the fuel cell stack.

4. The method of claim 1 further including detecting a water pressure between the water reservoir and the spray nozzle, and using detected values of the water pressure between the water reservoir and the spray nozzle to control a supply of water from the water reservoir to the spray nozzle downstream the humidifier to control the humidity of air entering the fuel cell stack.

5. The method of claim 1 further including using the detected values of the humidity of air entering the fuel cell stack air inlet downstream the humidifier to control operation of a pump to pump water from the water reservoir to a solenoid disposed to control the supply of water from the water reservoir to the spray nozzle downstream the humidifier to control the humidity of air entering the fuel cell stack.

6. The method of claim 1 further including separating water from air downstream a fuel cell exhaust line, and providing recovered water separated from air downstream to the water reservoir.

7. The method of claim 6 further including supplying air from the fuel cell exhaust line to the humidifier, and supplying a flow of air from the humidifier to a water separator, and providing water from the water separator to the water reservoir.

8. The method of claim 1 further including detecting a humidifier outlet humidity upstream the spray nozzle, detecting a humidifier outlet temperature, detecting a humidifier outlet pressure, and detecting a water pressure between the water reservoir and the spray nozzle, and using the detected values to control the supply of water from the water reservoir to the spray nozzle downstream the humidifier to control the humidity of air entering the fuel cell stack air inlet and to control operation of a pump to pump water from the water reservoir to a solenoid disposed to control the supply of water from the water reservoir to the spray nozzle downstream the humidifier to control the humidity of air entering the fuel cell stack air inlet.

9. A fuel cell system comprising:
a fuel cell stack including a fuel cell stack air inlet,
a stack inlet humidity sensor disposed to detect a humidity of air entering the fuel cell stack air inlet and to provide signals indicative of detected values of the humidity of air entering the fuel cell stack air inlet,
a humidifier including a humidifier outlet, the humidifier outlet being disposed upstream the fuel cell stack air inlet and the stack inlet humidity sensor to provide air to the fuel cell stack air inlet,
a reservoir,
a spray nozzle disposed to provide water from the reservoir to the air downstream the humidifier outlet and upstream the fuel cell stack air inlet,
a solenoid valve disposed to control flow of water from the reservoir to the spray nozzle, and
a controller configured receive signals from the stack inlet humidity sensor and to control operation of the solenoid at least based upon the signals from the stack inlet humidity sensor.

10. The fuel cell system of claim 9 further including at least one of a water level sensor disposed to detect a water level of the reservoir, and a humidifier outlet humidity sensor disposed to detect a humidifier outlet humidity upstream the spray nozzle.

11. The fuel cell system of claim 10 including a humidifier outlet temperature sensor disposed to detect a humidifier outlet temperature upstream the spray nozzle, and a humidifier outlet pressure sensor disposed to detect a humidifier outlet pressure upstream the spray nozzle, and a fluid pressure sensor disposed to detect a water pressure between the reservoir and the solenoid valve.

12. The fuel cell system of claim 9 further including a pump disposed to pump water from the reservoir to the solenoid valve, and a fluid pressure sensor disposed to detect a water pressure between the pump and the solenoid valve.

13. The fuel cell system of claim 12 further including a fuel cell exhaust line fluidly coupled to the fuel cell stack, a water separator fluidly coupled to the fuel cell exhaust line and to the reservoir.

14. The fuel cell system of claim 13 wherein the humidifier is fluidly connected to the fuel cell exhaust line and the water separator.

15. A fuel cell system controller adapted to control operation of a fuel cell system including a fuel cell stack having a fuel cell stack air inlet, a stack inlet humidity sensor disposed to detect a humidity of air entering the fuel cell stack air inlet, a humidifier including a humidifier outlet, the humidifier outlet being disposed upstream the fuel cell stack air inlet and the stack inlet humidity sensor to provide air to the fuel cell stack air inlet, a reservoir, a spray nozzle disposed to provide water from the reservoir to the air downstream the humidifier and upstream the fuel cell stack air inlet, and a solenoid valve disposed to control flow of water from the reservoir to the spray nozzle, the fuel cell system controller being configured to receive a signal indicative of the a detected value of a humidity at the fuel cell stack air inlet downstream the humidifier from the stack inlet humidity sensor, and use the detected value to control to control operation of the solenoid valve to control a supply of water from the water reservoir to the spray nozzle downstream the humidifier and upstream the fuel cell stack air inlet in order to control the humidity of air entering the fuel cell stack air inlet.

16. The fuel cell system controller of claim 15 further configured to receive a signal indicative of a detected value of a level of water within the reservoir from a water level sensor disposed to sense a level of water in the reservoir, and to control operation of a pump disposed to pump water from the reservoir to the solenoid valve.

17. The fuel cell system controller of claim 15 further configured to receive a signal indicative of a detected value of a water pressure upstream the solenoid valve from a fluid pressure sensor.

18. The fuel cell system controller of claim 15 further configured to receive a signal indicative of a detected value of a humidifier outlet humidity upstream the spray nozzle from a humidifier outlet humidity sensor, and use the detected values to control operation of the solenoid valve to control the humidity of air entering the fuel cell stack.

19. The fuel cell system controller of claim 18 further configured to receive signals indicative of a detected value of a humidifier outlet temperature upstream the spray nozzle from a humidifier outlet temperature sensor, and signals indicative of a detected value of a humidifier outlet pressure upstream the spray nozzle from a humidifier outlet pressure sensor, and using the detected values to control operation of the solenoid valve to control the supply of water from the water reservoir to the spray nozzle downstream the humidifier to control the humidity of air entering the fuel cell stack.

20. The fuel cell system controller of claim 18 further configured to receive a signal indicative of a water pressure upstream the solenoid valve from a pressure sensor.
